(19) United States
(12) Patent Application Publication
(10) Pub. No.: US 2013/0336130 A1
(43) Pub. Date: Dec. 19, 2013

(54) System and Method for Detecting Jamming in Wireless Networks

(71) Applicants: Vinayak Sadashiv Kore, Bangalore (IN); Mohammed Rizwan, Bangalore (IN)

(72) Inventors: Vinayak Sadashiv Kore, Bangalore (IN); Mohammed Rizwan, Bangalore (IN)

(73) Assignee: Honeywell International Inc., Morristown, NJ (US)

(21) Appl. No.: 13/495,877

(22) Filed: Jun. 13, 2012

(51) Int. Cl. H04W 24/08

(52) U.S. Cl. 370/252

(57) ABSTRACT

A method and apparatus for operating a security system. The method includes the steps of providing a plurality of wireless detectors within a security system, each of the plurality of wireless detectors exchanging packets with a control panel of the security system, at least one of the plurality of wireless detectors monitoring a wireless channel of a transmission radio frequency band for a periodically transmitted packet from another of the detectors, decoding the packet and forwarding the received packet to the control panel, the at least one wireless detector detecting radio frequency energy on the wireless channel and the at least one wireless detector transmitting a packet notifying the control panel of jamming upon failing to decode the periodically transmitted packet from the other wireless detector while continuing to detect radio frequency energy on the wireless channel in place of the periodically transmitted packet.

### FIELD

The field of the invention relates to security systems and more particularly to wireless detectors used in security systems.

### BACKGROUND

Security systems for homes and/or businesses are generally known. Such systems may be used for fire, burglary or any of a number of other known risks to life and/or safety.

In the case of a home or business, the security system may be based, first of all, on a physical barrier (e.g., walls, fences, etc.) around a secured area. One or more portals (e.g., doors, windows, etc.) may be provided to allow access into the secured area. Sensors may be placed adjacent each of the portals to detect entry by unauthorized persons into the secured area.

In some systems, the sensor at each portal may be connected to a local audible alarm. In other, more sophisticated systems, the sensors are connected to a control panel that monitors for security threats throughout the secured area. The control panel may activate a local alarm, on the panel, or alarms located throughout the secured area.

The control panel may also be coupled to a central monitoring station located remotely from the secured area. The central monitoring station may be manned 24/7 to report local alarms to the appropriate destination (e.g., fire, police, etc.).

The sensors of most security systems can be wired or wireless. When wireless, the security sensors are often powered by battery. However, wireless sensors are subject to failure due a number of factors including battery failure or interference. Because of the importance of such devices, better methods are needed to ensure the reliability of such devices.

### BRIEF DESCRIPTION OF THE DRAWING

FIG. 1 is a block diagram of a security system shown generally in accordance with an illustrated embodiment.

### DETAILED DESCRIPTION OF AN ILLUSTRATED EMBODIMENT

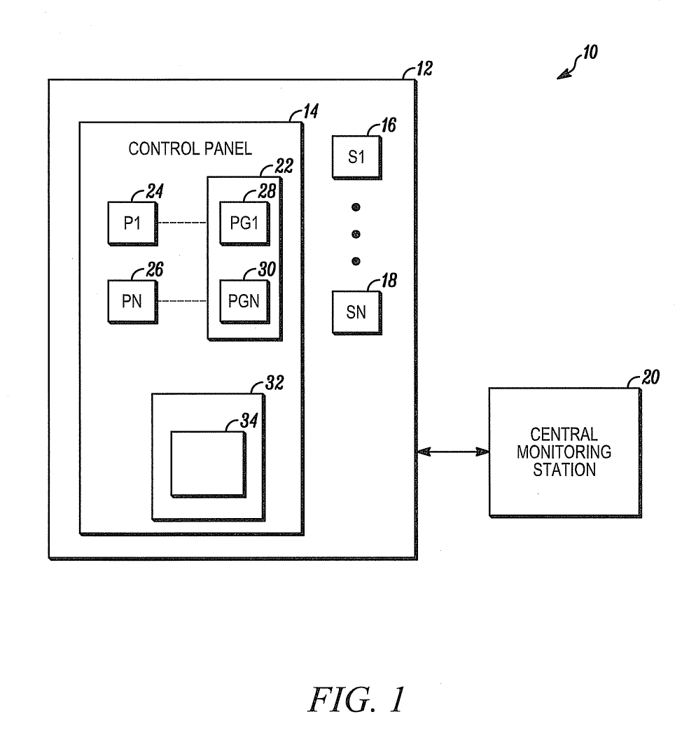

FIG. 1 is a block diagram of a security system 10 shown generally in accordance with an illustrated embodiment. The security system 10 is used to protect a secured area 12. Included within the secured area 12 may be a control panel 14 and a number of wireless detectors or sensors 16, 18.

The wireless detectors 16, 18 may be based upon any of a number of different technologies based upon the objective of the security system 10. For example, if the security system 10 is used for intrusion detection, the detectors 16, 18 may be coupled to doors or windows and may be embodied as wireless limit switches that detect opening of a door or window into the secure area 12. Alternatively, the wireless detectors 16, 18 may be optical devices that detect motion in the secured area 12. In any case, the wireless detectors 16, 18 would detect the opening of the respective door and window and send an alert back to the control panel 14.

Alternatively, the wireless detectors 16, 18 may by fire, smoke and/or any other environmental detector. In general, any combination of intrusion, fire, smoke or other environmental detectors 16, 18 may be used to protect people and property within the secured area 12.

The wireless detectors 16, 18 are embodied as wireless devices. In this regard, a transceiver 32 within each of the wireless detectors 16, 18 operate to exchange packets of information with a corresponding transceiver 32 within the control panel 14.

Included within the control panel 14 (and within each of the wireless detectors 16, 18) are a number of processors 24, 26 (embodied as hardware) that operate under control of one or more computer programs 28, 30 loaded from a non-transient computer readable medium (memory) 22. In this regard, reference to the functionality of a program 28, 30 herein is also a reference to the processor 24, 26 that executes that program 28, 30.

Within the control panel 14, at least one of the processors 24, 26 (e.g., an alarm processor) may operate to receive alerts (e.g., intrusion, fire, etc.) from wireless detectors 16, 18 through the respective transceivers 32. The alarm processor 24, 26 may receive the alert from the wireless detector 16, 18, compose an alarm packet and send that packet to the central monitoring station 20.

The security system 10 may have a number of different operating modes, including an armed mode, a disarmed mode, an arm stay mode and, possibly, other modes. If the security system 10 is a home security system, then the alarm processor 24, 26 may send intrusion alarms to the central monitoring station 20 in the armed or armed stay modes. Fire alarms may be sent in any mode.

The wireless detectors 16, 18 may be battery powered devices. In general, each of the wireless detectors 16 may incorporate an internal addressing system for that device. For example, each of the wireless detectors 16, 18 may have a set of address switches within the device by which the detector 16, 18 may be identified to the system 10 during installation (and by location within the secure area 12) via that address.

The control panel 14 may communicate with the wireless detectors 16, 18 under a time division multiple access (TDMA) format. In this regard, the exchange of packets between the devices may occur under a repeating communication frame controlled by the control panel 14.

In this regard, each of the wireless detectors 16, 18 may be assigned to a communication slot within the repeating frame. Upon startup of the system 10, a communication processor 24, 26 within each of the wireless detectors 16, 18 may register with a corresponding communication processor 24, 26 within the control panel 14. The communication processor 24, 26 within the control panel 14 may recognize each of the detectors 16, 18 as being part of the system 10 via the address programmed into that detector 16, 18.

Once registered with the system 10, the communication processor 24, 26 of the control panel 14 may assign each registered wireless detector 16, 18 to a respective slot of the repeating frame. In this regard, each registered wireless detector 16, 18 may periodically receive packets from the control panel 14 in one slot of the repeating frame and transmit response packets to the control panel 14 in the same or another slot of the repeating frame.

The wireless detectors 16, 18 may also operate as repeaters. In this regard, the wireless detectors 16, 18 may be low power devices that may not all be within range of the control panel 14. In this regard, those wireless detectors 16, 18 that have already registered with the control panel 14 may also monitor for registration messages from other wireless detectors 16, 18 that have been unable to register with the control panel 14. For example, a first wireless detector 16, 18 may be located too far from the control panel 14 to transmit a registration message that far. However, a second wireless detector 16, 18 may be located between the first wireless detector 16, 18 and the control panel 14. In this case, the second wireless detector 16, 18 may receive the registration packet, decode the registration packet and retransmit the registration packet to the control panel 14. The second wireless detector may transmit the registration message to the control panel 14 through the slot assigned to the second wireless detector or through a registration slot within the repeating frame reserved for such use.

In response, the control panel 14 may receive the registration message from the first wireless detector through the second wireless detector and proceed to register the first wireless detector as discussed above. In response, the control panel 14 may assign the first wireless detector 16, 18 to its own slot(s) within the repeating frame and send a packet notifying the first wireless detector 16, 18 of the assignment. The control panel 14 may transmit the notification within the slot assigned to the second detector 16, 18. The second detector 16, 18 may receive the notification packet from the control panel 14 and configure a communication processor 24, 26 within the second detector 16, 18 to exchange packets between the first detector 16, 18 and second detector 16, 18 and between the second detector 16, 18 and the control panel 14 on one or more of the assigned slot(s). In this regard, the communication processor 24, 26 of the second detector 16, 18 (functioning as a repeater) may also operate to set up and assign a different slot(s) of the repeating frame (reserved for repeaters) for exchanging packets with the first detector 16, 18.

Once set up, the second wireless detector 16, 18 may periodically exchange packets of the first detector 16, 18 with the control panel 14 on the slot(s) assigned by the control panel 14.

The system 10 may also operate to detect the presence of signals that jam communication between the wireless detectors 16, 18 and the control panel 14. Upon the detection of the presence of jamming, the control panel 14 may alert a person using the security system 10 of the presence of such jamming signals via an audio and/or audiovisual presentation through a user interface of the control panel 14.

In this regard, jamming may be detected via the monitoring of the assigned slot(s). Jamming in this context may be based upon the detection of signal energy and the absence of a decodable packet from the assigned slot(s). In this regard, the receiver 32 of the control panel 14 and each of the wireless detectors 16, 18 may include a signal energy measurement device (e.g., a received signal strength indicator (RSSI) device) 34. The signal energy measurement device 34 of the control panel 14 and devices 16, 18 may together operate to measure the signal energy within each slot of the repeating frame. A threshold value may be provided within the signal energy measurement device 34 as a mechanism to differentiate between a detectable signal and noise.

Also associated with each of the transceivers 32 is a packet processor 24, 26 associated with each of the transceivers 32. In this regard, the packet processor 24, 26 may examine the contents of designated slots of the repeating frame. If the slot contains a decodable packet, the packet processor may provide an indication of such to a jamming processor 24, 26. In this regard, the jamming processor 24, 26 receives an output from the signal energy measurement device 34 and the packet processor 24, 26 and provide an output whenever the slot contains signal energy above the threshold value, yet does not contain a decodable packet.

A time value may also be associated with the jamming processor 24, 26. For example, where signal energy above the threshold is found within the predetermined slot, but these are no decodable packets within the slot for some predetermined time period exceeding a threshold time value (e.g., 20 seconds), then the control panel 14 may display the jamming alert.

Under one illustrated embodiment, the control panel 14 and each of the repeating wireless detectors 16, 18 may contain one or more jamming processors 24, 26. In the example above, where a second detector 16, 18 operates as a repeater for a first wireless detector 16, 18, the corresponding jamming processor 24, 26 of the second detector 16, 18 may monitor the slot(s) assigned to the first detector 16, 18. Where the second detector 16, 18 determines that signal energy above the threshold is found within the slot(s) used for exchanging packets between the first and second detectors 16, 19, but these are no decodable packets within the slot for some time period that exceeds 20 seconds, then the second detector 16, 18 may send a jamming alert to the control panel 14. The control panel 14 then responds by providing the alert to the person operating the system 10.

In a similar manner, the control panel 14 may also monitor the respective slot assigned to each of the plurality of wireless detectors 16, 18 for jamming. When signal energy above the threshold is detected on any of the slot, but no decodable packets are present for the predetermined time period, then the control panel 14 may alert the user.

Under one illustrated embodiment, the jamming processor 24, 26 operating in conjunction with each predetermined slot resets the timer each time a decodable packet is detected within the designated slot. It is only when no decodable packets are received for the predetermined time period that an alert is generated.

Within the system 10, any detector 16, 18 that faces jamming communicates the jamming alert to its parent device(s). The parent devices 16, 18 which are outside the influence of the jamming source receive this alert and transmit it to the panel 14 as an indication of jamming trouble.

Upon detecting jamming which is intermittent in nature (e.g., a walkie-talkie or some other licensed high power device), the panel 14 can decide to change to a different frequency. To achieve this objective, the panel 14 needs to communicate with each network device 16, 18, including those being intermittently jammed, identifying a new set of channels (e.g., time slot and frequency) and a time to switch to those new channels. In the case of devices 16, 28 that are being intermittently jammed, the control panel 14 may notify the devices of the new channels in the periods between jamming episodes. In the case of permanent jamming, the panel 14 may not have the opportunity to instruct each device 16, 18 to move to other channels. In this case, the panel 14 may be limited to only provide a jamming trouble indication to a user on the user interface.

In another illustrated embodiment, each of the wireless detectors 16, 18 is provided with a sleep timer and sleep time processor 24, 26. In this regard, each detector 16, 18 deactivates itself and powers down between the slots in which it operates to either transmit or receive packets. The sleep timer and sleep timer processor 24, 26 reawakens the respective detector 16, 18 in the slot immediately prior to the slot in which the detector 16, 18 is to operate.

In another embodiment, the control panel 14 operates to detect and present an alert of the presence of jamming to an operator of the system 10. The control panel 14 may also present the operator with the option of changing an operating frequency and one or more alternate frequencies where the system 10 could operate without interference. The operator may avoid jamming by selecting one of the alternative frequencies presented by the control panel. In response, the control panel 14 may move the operating frequency of some or all of the detectors 16, 18 operating on the repeating frame to the margins of the band based upon the selection by the operator. The control panel 14 may do this by transmitting a packet to some or all of the plurality of wireless detectors 16, 18 instructing the detectors 16, 18 to move to the new operating frequency.

For example, some of the plurality of detectors 16, 18 may be operating near a source of interference. In this case, the control panel (in response to a selection made by the operator) may instruct the detectors 16, 18 operating near the source of interference to move to a different frequency. The reminder of the detectors 16, 18 may continue to operate on the original spectral location. Alternatively, in the case of the detection of jamming of the signals from some of the detectors 16, 18, all of the detectors 16, 18 may be moved to the new spectral location.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
providing a plurality of wireless detectors within a security system, each of the plurality of wireless detectors exchanging packets with a control panel of the security system either directly or through another of the plurality of wireless detectors;
at least one of the plurality of wireless detectors monitoring a wireless channel of a transmission radio frequency band for a periodically transmitted packet from another of the plurality of wireless detectors, decoding the packet and forwarding the received packet to the control panel;
the at least one wireless detector detecting radio frequency energy on the wireless channel; and
the at least one wireless detector transmitting a packet notifying the control panel of jamming upon failing to decode the periodically transmitted packet from the other wireless detector while continuing to detect radio frequency energy on the wireless channel in place of the periodically transmitted packet.

2. The method of claim 1 further comprising the control panel and plurality of wireless detectors exchanging packets under a time division multiple access format defined by the control panel.

3. The method as in claim 2 further comprising synchronizing each of the plurality of wireless detectors to an assigned slot of a repeating frame of slots under the time division multiple access format defined by the control panel.

4. The method as in claim 3 further comprising automatically deactivating at least some of the plurality of wireless detectors between assigned slots.

5. The method as in claim 1 further comprising the control panel displaying a jamming alert notice to a user of the security system.

6. The method of claim 1 further comprising the at least one wireless detector activating a timer upon detecting rf energy but failing to detect the packet from the other wireless detector.

7. The method as in claim 6 further comprising the at least one wireless detector resetting the timer each time a packet is received from the other wireless detector.

8. The method as in claim 6 further comprising the at least one wireless detector transmitting the packet notifying the control panel of jamming upon detecting the timer has exceeded a predetermined time limit.

9. Apparatus comprising:
a plurality of wireless detectors provided within a security system, each of the plurality of wireless detectors exchange packets with a control panel of the security system either directly or through another of the plurality of wireless detectors;
at least one of the plurality of wireless detectors monitors a wireless channel of a transmission radio frequency band for a periodically transmitted packet from another of the plurality of wireless detectors, decodes the packet and forwards the received packet to the control panel;
the at least one wireless detector detects radio frequency energy on the wireless channel; and
the at least one wireless detector transmits a packet notifying the control panel of jamming upon failing to decode the periodically transmitted packet from the other wireless detector while continuing to detect radio frequency energy on the wireless channel in place of the periodically transmitted packet.

10. The apparatus of claim 9 further comprising the control panel and plurality of wireless detectors exchange packets under a time division multiple access format defined by the control panel.

11. The apparatus as in claim 10 further comprising each of the plurality of wireless detectors synchronized to an assigned slot of a repeating frame of slots under the time division multiple access format defined by the control panel.

12. The apparatus as in claim 11 further comprising at least some of the plurality of wireless detectors deactivate themselves between assigned slots.

13. The apparatus as in claim 9 further comprising a user interface of the control panel that displays a jamming alert notice to a user of the security system.

14. The apparatus of claim 9 further comprising the at least one wireless detector activating a timer upon failure to detect the packet from the other wireless detector.

15. The apparatus as in claim 14 further comprising the at least one wireless detector includes a processor that resets the timer each time a packet is received from the other wireless detector.

16. The apparatus as in claim 14 further comprising the at least one wireless detector transmits the packet notifying the control panel of jamming upon detecting the timer has exceeded a predetermined time limit.

17. Apparatus comprising:
a control panel of a security system;
a plurality of wireless detectors located within a secured area of the security system, each of the plurality of wireless detectors exchange packets with the control panel of the security system either directly or through another of the plurality of wireless detectors;
at least one of the plurality of wireless detectors operates to monitor a wireless channel of a transmission radio frequency band for a periodically transmitted packet from another of the plurality of wireless detectors, decodes the packet and forwards the received packet to the control panel;
the at least one wireless detector detects radio frequency energy on the wireless channel; and
the at least one wireless detector transmits a packet notifying the control panel of jamming upon failing to decode the periodically transmitted packet from the other wireless detector while continuing to detect radio frequency energy on the wireless channel in place of the periodically transmitted packet.

18. The apparatus as in claim 17 wherein the control panel and each of the plurality of wireless devices further comprise one or more processors that detect jamming.

19. The apparatus as in claim 17 further comprising a repeating communication frame that each of the plurality of wireless detectors use to exchange packets with the control panel.

20. The apparatus as in claim 17 further comprising a jamming processor that detects the absence of packets in conjunction with the presence of radio frequency energy.
